(19) United States
(12) Patent Application Publication
(10) Pub. No.: US 2026/0116281 A1
(43) Pub. Date: Apr. 30, 2026

(54) INTEGRATED SECOND ROW ADJUSTABLE SEAT ASSEMBLY

(71) Applicant: GM Global Technology Operations LLC, Detroit, MI (US)

(72) Inventors: Minseok Jeon, Gimpo City (KR); Alejandro Barrera, Cuauhtemoc (MX); Eunjin Cho, Gyeonggi-do (KR); Yunho Go, Yeonsu-gu (KR); Jeongkeun Lee, Yeonsu-gu (KR)

(73) Assignee: GM Global Technology Operations LLC, Detroit, MI (US)

(21) Appl. No.: 18/927,839

(22) Filed: Oct. 25, 2024

(51) Int. Cl. B60N 3/06; B60N 2/32; B60N 2/64

(52) U.S. Cl. CPC B60N 3/063; B60N 2/32; B60N 2/646

(57) ABSTRACT

A vehicular seat assembly includes a seat bottom having a base portion and a pivoting portion. The base portion has a first cushion disposed at a first shell and the pivoting portion has a second cushion disposed at a second shell and a footrest. The seat bottom is adjustable between a first state and a second state. In the first state, the first shell, the second shell, and the footrest are concealed beneath the first cushion and the second cushion, and the first cushion and the second cushion cooperate to provide a sitting surface. In the second state, the pivoting portion is moved about a pivot axis away from the base portion so that the first cushion provides the sitting surface and the footrest is exposed to provide a footrest surface.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to seating in a vehicle, and specifically, to seating for a child in a second row of the vehicle. Seats in vehicles are sized to accommodate adults and are generally too large to accommodate a child, regardless of where the seat is located within the vehicle. To safely and comfortably accommodate a child in a seat of the vehicle, modifications to the seating arrangement are necessary. As a result, a booster seat is commonly installed at a seat of the vehicle to offer a child a comfortable and safe seat during vehicle travel. Furthermore, it is common for the booster seat to be installed rearward of a front row of a vehicle, such as at a seating position in the second row or third row of the vehicle.

Installing a booster seat in the vehicle typically requires manipulating the seating arrangement, such as by anchoring the booster seat to an anchor-point at or near the seating position, attaching a seatbelt to the booster seat, and the like. Furthermore, the booster seat must be uninstalled and removed from the vehicle to accommodate an adult passenger, and the booster seat will subsequently have to be re-installed to later accommodate a child. Repeated installation and removal of the booster seat, combined with storage of the booster seat when removed from the vehicle, may be challenging and cumbersome. Additionally, as a child grows in size, the booster seat may need to be replaced for a larger booster seat to properly accommodate the child in the vehicle.

### SUMMARY

One aspect of the disclosure provides a vehicular seat assembly. The vehicular seat assembly includes a seat bottom having a base portion and a pivoting portion. The base portion has a first cushion disposed at a first shell and the pivoting portion has a second cushion disposed at a second shell and a footrest. The seat bottom is adjustable between a first state and a second state. In the first state, the first shell, the second shell, and the footrest are concealed beneath the first cushion and the second cushion, and the first cushion and the second cushion cooperate to provide a sitting surface configured to support a user sitting at the vehicular seat assembly. In the second state, the pivoting portion is moved about a pivot axis away from the base portion so that the first cushion provides the sitting surface and the footrest is exposed to provide a footrest surface configured to support feet of the user sitting at the vehicular seat assembly.

Implementations of this aspect of the disclosure may include one or more of the following optional features. In some examples, a hinge pivotally attaches the pivoting portion relative to the base portion, the hinge defining the pivot axis. In some further examples, the hinge includes at least one selected from the group consisting of (i) a flexible hinge that extends between the pivoting portion and the base portion and (ii) a pivotal bracket attached to the pivoting portion and the base portion. In some even further examples, the hinge includes a ratcheting mechanism configured to secure a position of the pivoting portion relative to the base portion at one of a plurality of positions about the pivot axis.

In some implementations, with the seat bottom in the second state, the first cushion is adjustable relative to the first shell to adjust a height of the sitting surface.

In some configurations, with the seat bottom in the second state, the footrest is adjustable relative to the second shell to adjust a height of the footrest surface.

In some examples, with the seat bottom in the first state, a cover extends over the first cushion and the second cushion to provide the sitting surface, and with the seat bottom in the second state, the cover is removed from at least the first cushion. In some further examples, with the seat bottom in the first state, the cover attaches to the first cushion and the second cushion via hook and loop fasteners.

In some implementations, with the seat bottom in the first state, the first cushion is connected to the second cushion to secure the seat bottom in the first state. In some further implementations, with the seat bottom in the first state, the first cushion is connected to the second cushion via a zipper.

Another aspect of the disclosure provides a vehicular seat assembly. The vehicular seat assembly includes a bench seat having a first sitting position, a second sitting position, and a third sitting position, wherein at least one of the first sitting position, the second sitting position, and the third sitting position includes a seat bottom. The seat bottom has a base portion and a pivoting portion. The base portion has a first cushion disposed at a first shell and the pivoting portion having a second cushion disposed at a second shell and a footrest. The seat bottom is adjustable between a first state and a second state. In the first state, the first shell, the second shell, and the footrest are concealed beneath the first cushion and the second cushion, and the first cushion and the second cushion cooperate to provide a sitting surface configured to support a user sitting at the vehicular seat assembly. In the second state, the pivoting portion is moved about a pivot axis away from the base portion so that the first cushion provides the sitting surface and the footrest is exposed to provide a footrest surface configured to support feet of the user sitting at the vehicular seat assembly.

Implementations of this aspect of the disclosure may include one or more of the following optional features. In some examples, a hinge pivotally attaches the pivoting portion relative to the base portion, the hinge defining the pivot axis.

In some implementations, with the seat bottom in the second state, the first cushion is adjustable relative to the first shell to adjust a height of the sitting surface.

In some configurations, with the seat bottom in the second state, the footrest is adjustable relative to the second shell to adjust a height of the footrest surface.

In some examples, with the seat bottom in the first state, the first cushion is connected to the second cushion to secure the seat bottom in the first state.

Yet another aspect of the disclosure provides a vehicle. The vehicle includes a seat assembly. The seat assembly includes a seat bottom having a base portion and a pivoting portion. The base portion has a first cushion disposed at a first shell and the pivoting portion has a second cushion disposed at a second shell and a footrest. The seat bottom is adjustable between a first state and a second state. In the first state, the first shell, the second shell, and the footrest are concealed beneath the first cushion and the second cushion, and the first cushion and the second cushion cooperate to provide a sitting surface configured to support a user sitting at the seat assembly. In the second state, the pivoting portion is moved about a pivot axis away from the base portion so that the first cushion provides the sitting surface and the footrest is exposed to provide a footrest surface configured to support feet of the user sitting at the seat assembly.

Implementations of this aspect of the disclosure may include one or more of the following optional features. In some examples, a hinge pivotally attaches the pivoting portion relative to the base portion, the hinge defining the pivot axis.

In some implementations, with the seat bottom in the second state, the first cushion is adjustable relative to the first shell to adjust a height of the sitting surface.

In some configurations, with the seat bottom in the second state, the footrest is adjustable relative to the second shell to adjust a height of the footrest surface.

In some examples, with the seat bottom in the first state, the first cushion is connected to the second cushion to secure the seat bottom in the first state.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a vehicular seat assembly according to the present disclosure;

FIG. 2A is a perspective view of the vehicular seat assembly of FIG. 1 including a seat bottom in a first state;

FIG. 2B is a perspective view of the vehicular seat assembly of FIG. 2A including the seat bottom in a second state;

FIG. 3A is a perspective view of the seat bottom of FIG. 2A including a flexible hinge according to the present disclosure;

FIG. 3B is a perspective view of a pivotal bracket according to the present disclosure;

FIG. 4A is a perspective view of the seat bottom of FIG. 2A including a ratcheting mechanism securing a pivoting portion of the seat bottom in a first position;

FIG. 4B is a perspective view of the seat bottom of FIG. 4A including the ratcheting mechanism securing the pivoting portion of the seat bottom in a second position;

FIGS. 5A and 5B are exploded views of the ratcheting mechanism of FIG. 4A;

FIG. 5C is a cross-sectional view of the ratcheting mechanism of FIG. 4A;

FIG. 6 is a perspective view of the seat bottom of FIG. 2A with a shell of the seat bottom removed to show a frame assembly;

FIG. 7A is a perspective view of the seat bottom of FIG. 2A with a cover extending over the seat bottom;

FIG. 7B is a perspective view of the seat bottom of FIG. 7A with the cover removed from the seat bottom;

FIG. 8A is a perspective view of the seat bottom of FIG. 2A including a zipper attaching a pivoting portion of the seat bottom to a base portion of the seat bottom;

FIG. 8B is a perspective view of the seat bottom of FIG. 8A with the zipper detached and the seat bottom moved to the second state;

FIG. 9A is a perspective view of the seat bottom of FIG. 2A including a first cushion in a default position;

FIG. 9B is a perspective view of the seat bottom of FIG. 9A including the first cushion in a raised position;

FIG. 9C is an exploded view of a base portion of the seat bottom of FIG. 9A;

FIG. 9D is a cross-sectional view of the base portion of the seat bottom of FIG. 9A;

FIG. 9E is a perspective view of an adjustment lever of the base portion of the seat bottom of FIG. 9A;

FIG. 9F is an enlarged sectional view of the base portion of the seat bottom of FIG. 9D;

FIG. 10A is a perspective view of the seat bottom of FIG. 2A including a footrest in a default position;

FIG. 10B is a perspective view of the seat bottom of FIG. 10A including the footrest in a raised position; and

FIG. 10C is an exploded view of a pivoting portion of the seat bottom of FIG. 10A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

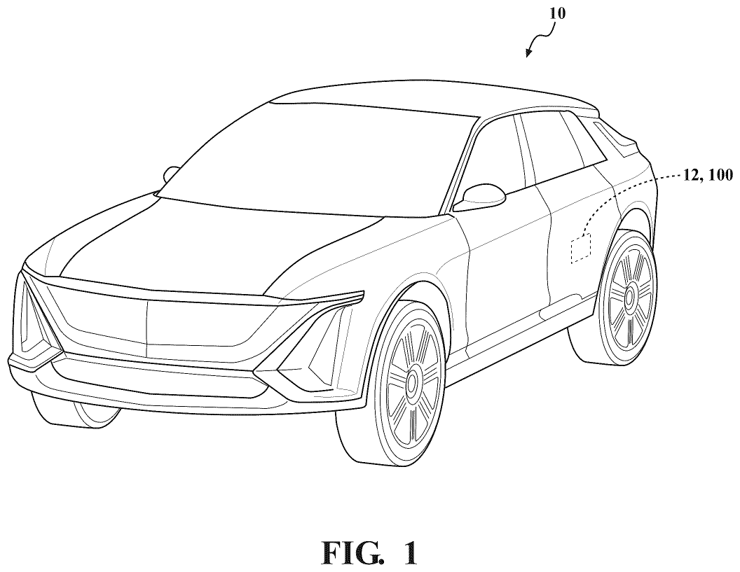

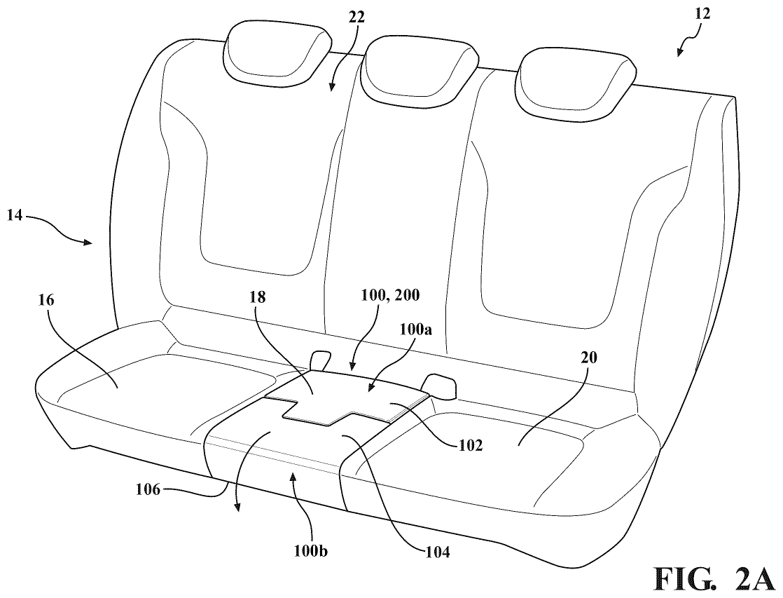

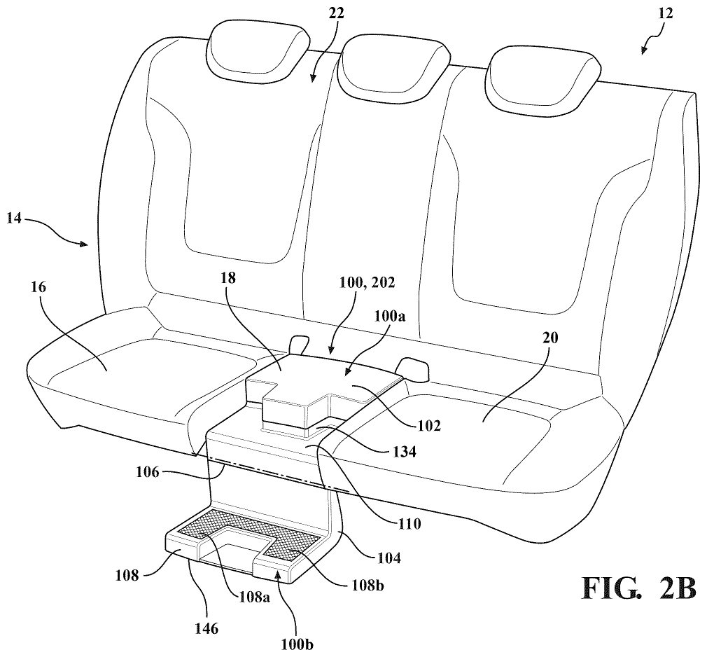

With reference to FIGS. 1-2B, a vehicle 10 includes a vehicular seat assembly 12 having one or more seating positions configured to provide seating to respective occupants of the vehicle 10. In the illustrated example, the vehicular seat assembly 12 includes a bench seat 14 that includes a first seating position 16, a second seating position 18, and a third seating position 20. While the illustrative examples show the bench seat 14 as including three seating positions 16, 18, 20, it can be appreciated that the bench seat 14 may include fewer or additional seating positions without deviating from the context of this disclosure. Further, the seat assembly may include a single seating position, such as a captain's chair or an individual bucket seat, without deviating from the context of this disclosure. The vehicular seat assembly 12 also includes a back portion 22 positioned rearward of the seating positions 16, 18, 20 of the bench seat 14 that is configured to interface with a backside of a user when sitting at the vehicular seat assembly 12.

A seat bottom 100 is included at the vehicular seat assembly 12 and integrated with at least one of the first seating position 16, the second seating position 18, and the third seating position 20. In the illustrative examples, the seat bottom 100 is shown at the second seating position 18, however, the seat bottom 100 may be included at any or all of the seating positions 16, 18, 20 without deviating from the context of this disclosure. The seat bottom 100 includes a base portion 100a and a pivoting portion 100b. The base portion 100a is positioned closest to the back portion 22 of the vehicular seat assembly 12, while the pivoting portion 100b is positioned furthest from the back portion 22 of the vehicular seat assembly 12.

As shown in FIG. 2A, the base portion 100a of the seat bottom 100 includes a first cushion 102 configured to interface with an occupant of the second seating position 18. In a similar manner, the pivoting portion 100b of the seat bottom 100 includes a second cushion 104 configured to interface with the occupant of the second seating position 18. Both the first cushion 102 and the second cushion 104 may be of similar material and may include similar cushioning as the material and cushioning of the first seating position 16 and the third seating position 20. In this regard, the seat bottom 100 maintains a similar interface with an occupant of the second seating position 18 as occupants at the first seating position 16 and the third seating position 20.

As shown in FIG. 2B, the first cushion 102 is disposed at a first shell 134 of the base portion 100a wherein the first shell 134 provides rigidity and structure to the base portion 100a. In a similar manner, the second cushion 104 is disposed at a second shell 146 of the pivoting portion 100b wherein the second shell 146 provides rigidity and structure to the base portion 100a. Both the first shell 134 and the second shell 146 may be of rigid material such as acrylonitrile butadiene styrene (ABS) plastic, metal, hard rubber, and the like. Further, the first shell 134 of the base portion 100a includes a mounting portion 110 and the second shell 146 of the pivoting portion 100b includes a footrest 108. The mounting portion 110 may securely attach the seat bottom 100 to the vehicular seat assembly 12, and optionally may be integrally formed with a base or shell of the bench seat 14. The first shell 134 may extend from and/or be integrally formed with the mounting portion 110. The footrest 108 is disposed at and/or integrally formed with the second shell 146 and provides an interface for a user to position their feet when the seat bottom 100 is in a use position or unfolded position, the details of which will be described in greater detail below.

With continued reference to FIGS. 2A and 2B, the seat bottom 100 is adjustable between a first state 200 (FIG. 2A) and a second state 202 (FIG. 2B). In the first state 200, the first shell 134, the second shell 146, the mounting portion 110, and the footrest 108 are concealed beneath the first cushion 102 and the second cushion 104. Both the first cushion 102 and the second cushion 104 face upward and are configured to interface with a user sitting at the seat bottom 100. In this regard, the seat bottom 100 in the first state 200 is configured similarly to the first seating position 16 and the third seating position 20 of the bench seat 14 by providing a sitting surface for the occupant. Further, the first cushion 102 and the second cushion 104 cooperate and fit together to provide a smooth and unencumbered sitting surface that is free of substantial gaps or cavities between the first cushion 102 and the second cushion 104. Although shown has having corresponding and interlocking shapes where a protrusion of the base portion 100a is received within a recess of the pivoting portion 100b, it should be understood that the base portion 100a and the pivoting portion 100b may have any suitably corresponding shapes that provide a substantially continuous seating surface for the user when in the first state 200.

The seat bottom 100 is transitioned from the first state 200 to the second state 202 when the pivoting portion 100b is manually pivoted about a pivot axis 106 and away from the base portion 100a. In other words, the pivoting portion 100b pivots forward of the bench seat 14 and comes to rest below the bench seat 14 when the seat bottom 100 is in the second state 202. For example, a user may pull on the pivoting portion 100b to pivot the pivoting portion 100b relative to the base portion 100a about the pivot axis 106 and move the seat bottom 100 to the second state 202. The footrest 108, as well as portions of the first shell 134, the second shell 146, and the mounting portion 110 may be exposed when the seat bottom 100 is in the second state 202.

The seat bottom 100 is configured to accept a child occupant when the seat bottom 100 is in the second state 202. In this regard, the child occupant interfaces with the first cushion 102 of the base portion 100a and the footrest 108 of the pivoting portion 100b. The footrest 108 includes a first footrest surface 108a and a second footrest surface 108b on an opposing side of the footrest 108 from the first footrest surface 108a, with both the first footrest surface 108a and the second footrest surface 108b configured to interface with individual feet of the child occupant. The first footrest surface 108a and the second footrest surface 108b may include non-slip/non-skid and rigid material to provide coarse and firm footing for feet of the child occupant. Optionally, the child occupant may position feet at the mounting portion 110 while simultaneously interfacing with the first cushion 102 of the base portion 100a, such as when the child occupant is unable to reach the footrest 108 while sitting at first cushion 102.

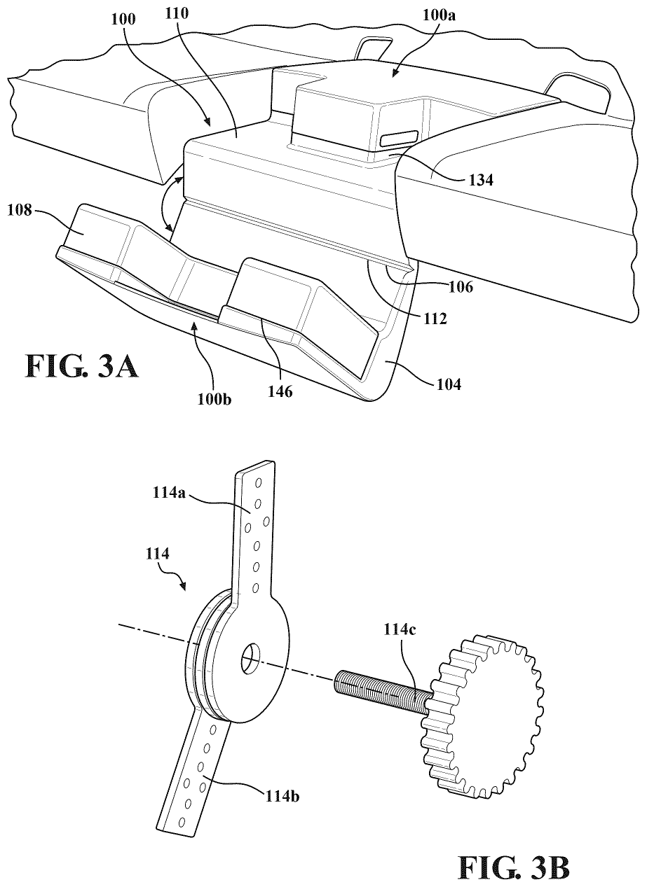

The pivoting portion 100b is pivotally attached to the base portion 100a and pivots about the pivot axis 106 between the first state 200 and the second state 202. For example, and as shown in FIG. 3A, a living hinge or flexible hinge 112 may connect the base portion 100a with the pivoting portion 100b and define the pivot axis 106. The flexible hinge 112 enables pivoting of the pivoting portion 100b about the pivot axis 106 to transition the seat bottom 100 between the first state 200 and the second state 202. The flexible hinge 112 may include a flexible material attached at or near the first shell 134 and the second shell 146, such as fabric, rubber, or something of the like that resists damage or degradation as a result of hinging. The pivot axis 106 may extend along a longitudinal axis of the flexible hinge 112.

Optionally, and as shown in FIG. 3B, a pivotal bracket 114 may connect the base portion 100a with the pivoting portion 100b and define the pivot axis 106. The pivotal bracket 114 enables pivoting of the pivoting portion 100b about the pivot axis 106 to transition the seat bottom 100 between the first state 200 and the second state 202. The pivotal bracket 114 includes a first portion 114a that attaches at or near the first shell 134 of the base portion 100a, and a second portion 114b that attaches at or near the second shell 146 of the pivoting portion 100b, with the first portion 114a pivotal relative to the second portion 114b about a pivot pin 114c. The pivot axis 106 may extend along a longitudinal axis of the pivot pin 114c. Respective pivotal brackets 114 may be attached at opposing sides of the seat bottom 100.

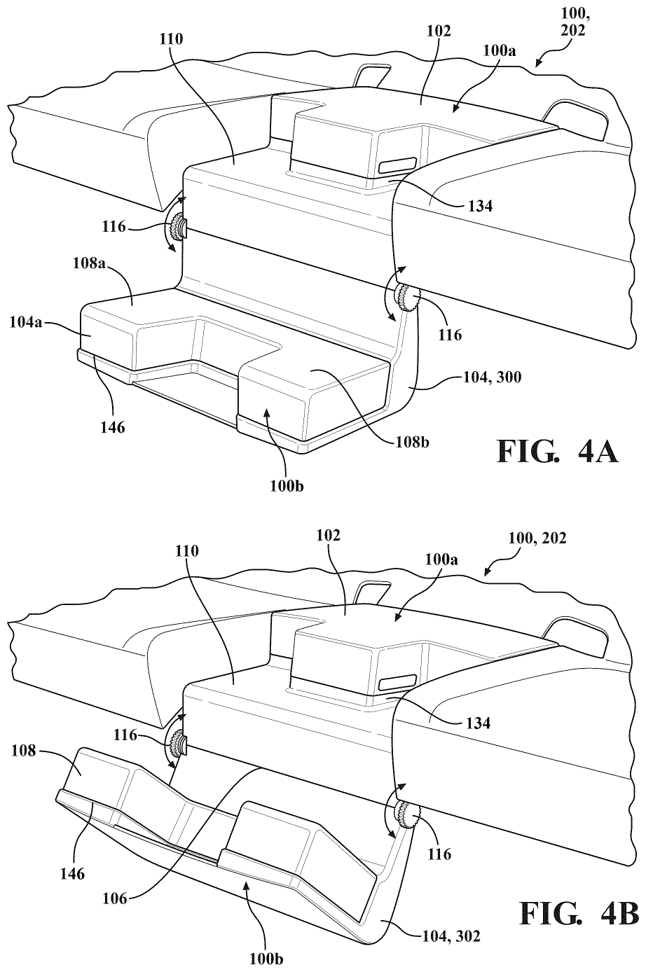

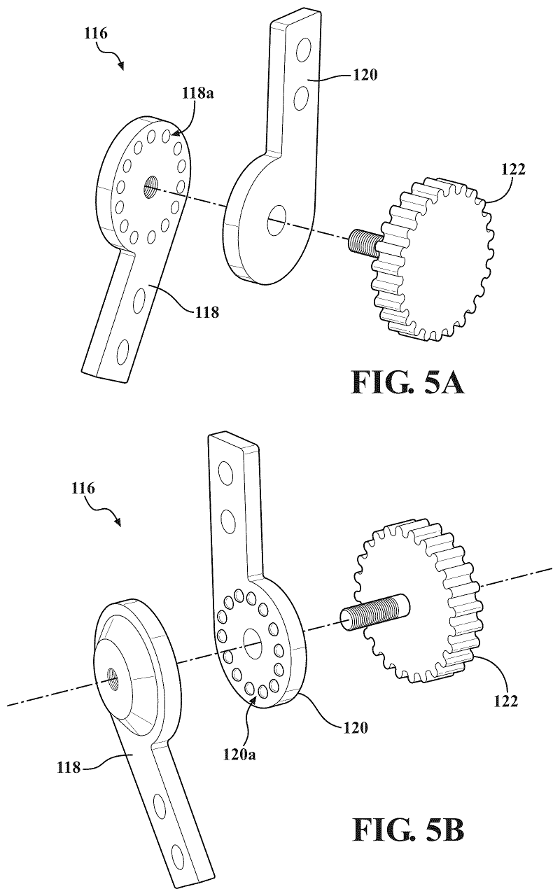

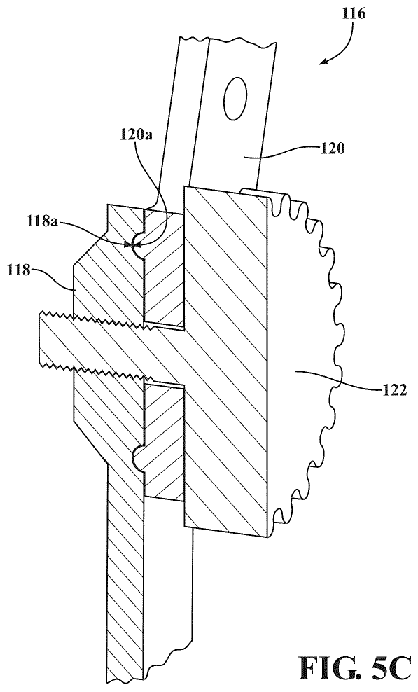

With reference to FIGS. 4A-5C, the seat bottom 100 may further include a ratcheting mechanism 116 configured to secure an angle of the pivoting portion 100b when the seat bottom 100 is in the second state 202. In other words, the ratcheting mechanism 116 provides angular adjustability to the pivoting portion 100b, enabling the footrest 108 to maintain a comfortable and accommodating position depending on the size of an occupant utilizing the seat bottom 100. Put another way, when the pivoting portion 100b is pivotally adjusted relative to the base portion 100a, the ratcheting mechanism 116 may secure the pivoting portion 100b at a plurality of angular positions relative to the base portion 100a between the first state 200 and the second state 200b. The ratcheting mechanism 116 may offer numerous angular positions of the pivoting portion 100b. For example, with specific reference to FIG. 4A, the pivoting portion 100b is at a first position 300 relative to the base portion 100a when the pivoting portion 100b is fully opened and at its lowest position (e.g., the second state 202 of the seat bottom 100). With specific reference to FIG. 4B, the pivoting portion 100b is at a second position 302 when the pivoting portion 100b is partially opened and between its lowest position and a closed position (e.g., at a position between the second state 202 of the seat bottom 100 and the first state 200 of the seat bottom 100). It should be appreciated that the ratcheting mechanism 116 may enable the pivoting portion 100b to be fixed at additional positions relative to the base portion 100a beyond the first position 300 and the second position 302.

The ratcheting mechanism 116 may include a pivoting portion attachment 118 that attaches to the pivoting portion 100b, a base portion attachment 120 that attaches to the base portion 100a, and an adjustment handle 122 that enables pivoting of the pivoting portion attachment 118 and the pivoting portion 100b relative to the base portion attachment 120 and the base portion 110a. The pivoting portion attachment 118 may include a plurality of cavities or recesses 118a that interface with a plurality of nubs 120a included at the base portion attachment 120. The cavities 118a may be circumferentially spaced along the pivoting portion attachment 118 and may be concentric with the pivot axis 106. The nubs 120a may be circumferentially spaced along the base portion attachment 120 and may be concentric with the pivot axis 106. As the pivoting portion 100b is pivoted relative to the base portion 100a, individual nubs 120a may move into and out of engagement with individual cavities 118a, with the nubs 120a engaging the cavities 118a to lock the pivoting portion 100b relative to base portion 100a at respective pivoting positions. The adjustment handle 122 may clamp the pivoting portion attachment 118 and the base portion attachment 120 together at a desired pivoting portion to lock the cavities 118a and nubs 120a and the base portion 100a and pivoting portion 100b relative to one another. For example, an occupant may loosen the adjustment handle 122 to disengage the plurality of cavities 118a with the plurality of nubs 120a. This enables the pivoting portion 100b to be transitioned between different positions when the seat bottom 100 is in the second state 202 or when the seat bottom 100 is between the first state 200 and the second state 202. Similarly, an occupant may tighten the adjustment handle 122 to engage the plurality of cavities 118a with the plurality of nubs 120a, thus fixing the pivoting portion 100b at a desired position, such as at the first position 300, at the second position 302, or a different position. The ratcheting mechanism 116 may be integrated with the pivotal bracket 114 as a single unit.

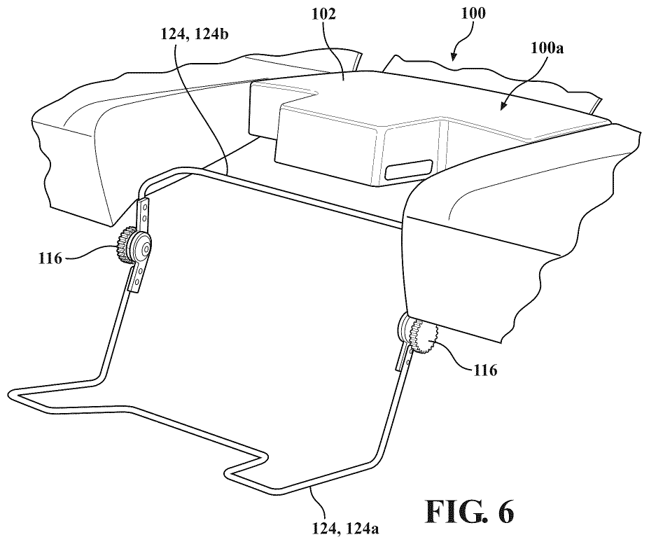

As shown in FIG. 6, the base portion 100a and the pivoting portion 100b may be mounted to a frame 124 that enables pivoting of the pivoting portion 100b relative to the base portion 100a. Specifically, the pivoting portion 100b may be mounted to a bottom portion 124a of the frame 124 and the base portion 100a may be mounted to a top portion 124b of the frame 124. The frame 124 may be a rigid material such as metal, ABS plastic, and the like. In the illustrated example, the top portion 124b of the frame 124 is attached to the base portion attachment 120 of the ratcheting mechanism 116 and the bottom portion 124a of the frame 124 is attached to the pivoting portion attachment 118 of the ratcheting mechanism 116, thus enabling pivoting of the bottom portion 124a and the pivoting portion 100b relative to the top portion 124b and the base portion 100a.

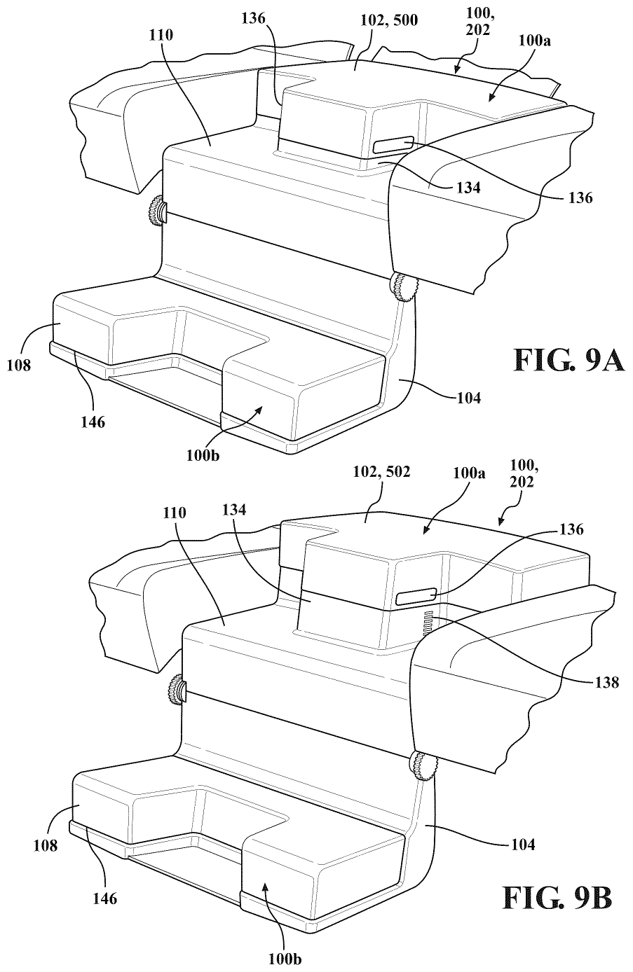

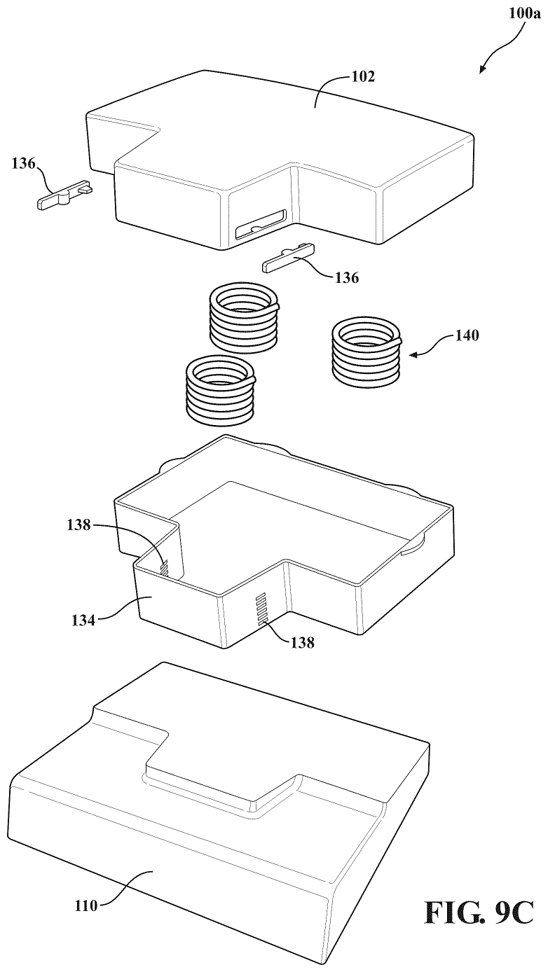

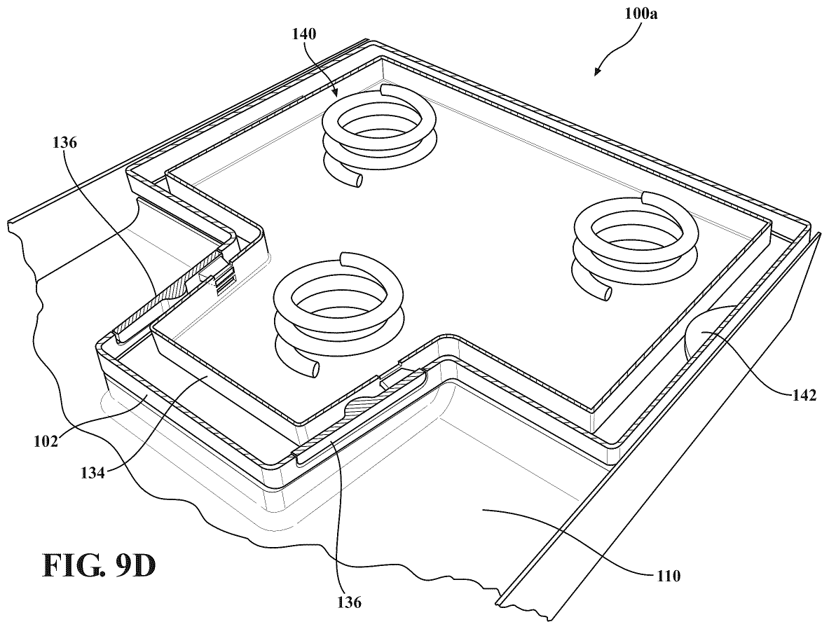

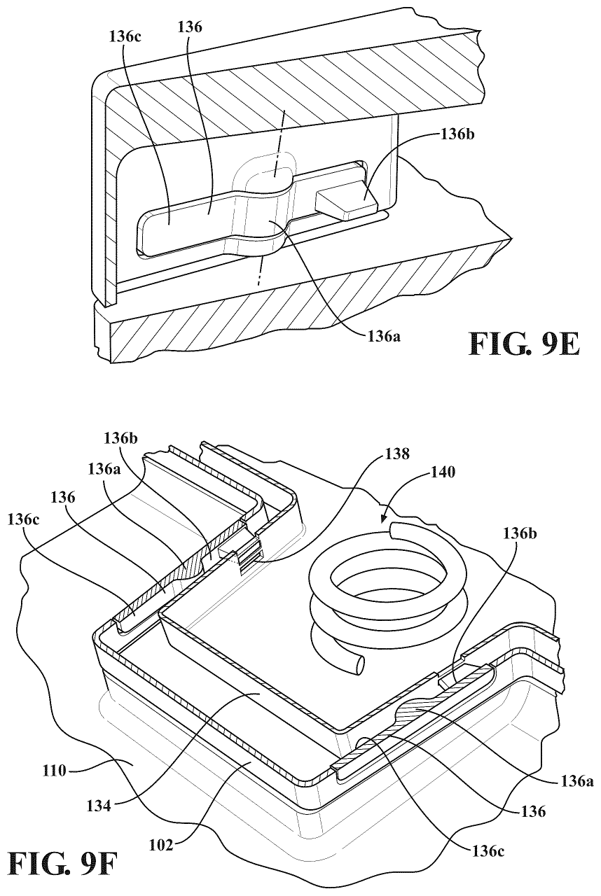

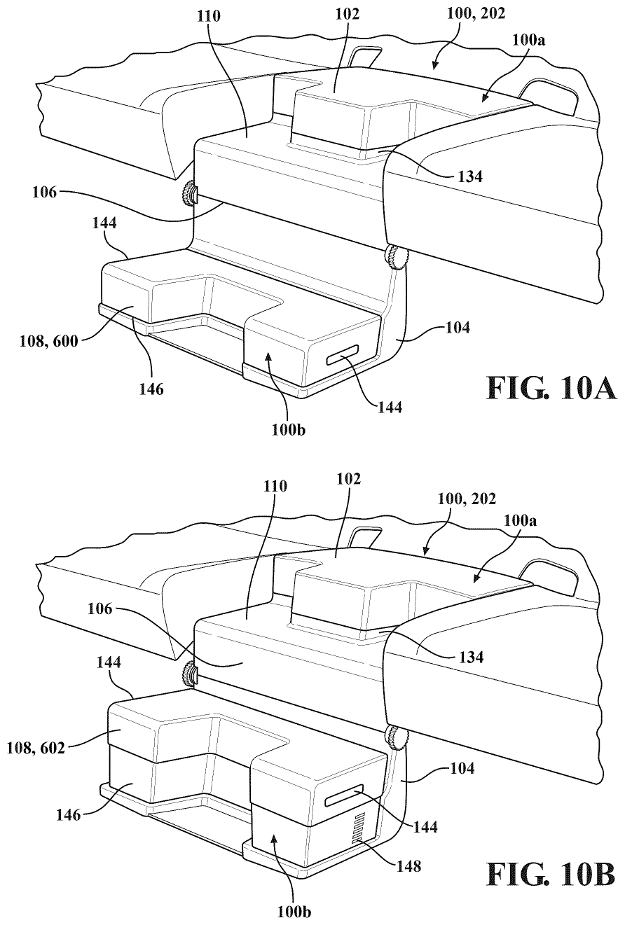

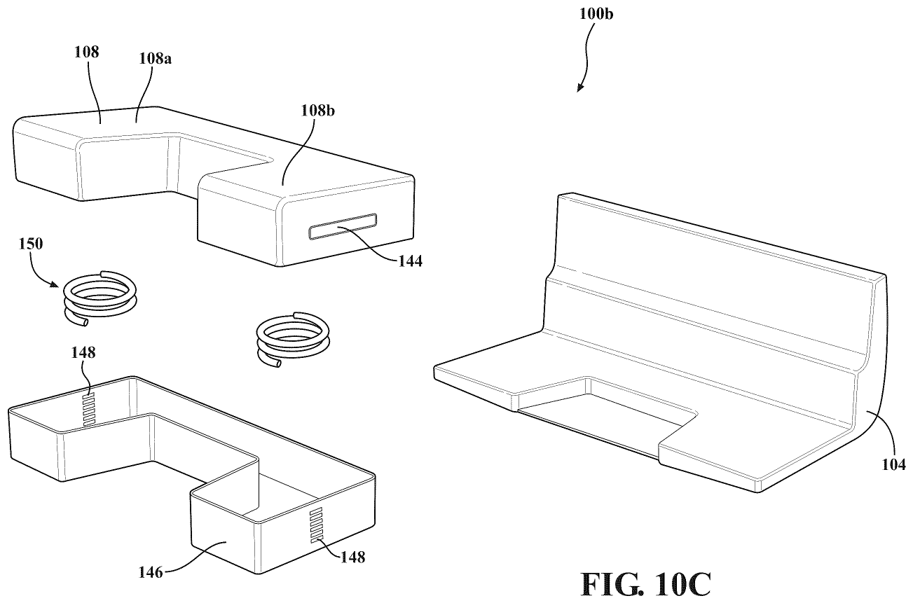

With reference to FIGS. 9A-10C, with the seat bottom 100 in the second state 202, the first cushion 102 is adjustable relative to the first shell 134 and the footrest 108 is adjustable relative to the second shell 146 to raise and lower the first cushion 102 and the footrest 108 to accommodate a variety of occupants of various sizes.

With specific reference to FIGS. 9A-9F, the first cushion 102 is adjustable relative to the first shell 134 to adjust a height of the sitting surface. For example, the first cushion 102 may be adjusted upward and away from the first shell 134 to accommodate a tall occupant. Alternatively, the first cushion 102 may be adjusted downward and toward the first shell 134 to accommodate a short occupant. For example, with specific reference to FIG. 9A, the first cushion 102 is in a default position or minimum height position 500 where the first cushion 102 is positioned closest to the first shell 134, thus as downward as possible. With specific reference to FIG. 9B, the first cushion 102 is movable from the default position 500 to one or more extended or raised positions 502, where the first cushion 102 is positioned away from the first shell 134, thus upward of the default position 500. The first cushion 102 may be adjustable to a plurality of extended positions that provide the seating surface at a variety of different heights relative to the first shell 134, such as to accommodate occupants of different sizes.

As shown in FIGS. 9C-9F, at least one adjustment lever 136 is disposed at the first cushion 102 to enable adjustment of the first cushion 102 between varying positions. The adjustment lever 136 is pivotable relative to the first shell 134 about a pivot point or attachment point 136a, and the adjustment lever 136 includes an engagement tab 136b and a lever press 136c on an opposing side of the attachment point 136a from the engagement tab 136b. The engagement tab 136b is configured to engage with one of a plurality of tab slots 138 disposed at the first shell 134 to secure the first cushion 102 in respective positions relative to the first shell 134. In other words, engaging the engagement tab 136b with one of the plurality of tab slots 138 fixes the height of the first cushion 102 relative to the first shell 134. Disengaging the engagement tab 136b from one of the plurality of tab slots 138 enables the first cushion 102 to raise and lower relative to the first shell 134, thus adjusting the height of the first cushion 102. The adjustment lever 136 may be biased toward engagement with the plurality of tab slots 138. For example, a user may engage the lever press 136c and compress the lever press 136c toward the first shell 134 to move the engagement tab 136b out of engagement with one of the plurality of tab slots 138 and thus free the first cushion 102 to move relative to the first shell 134. Releasing the lever press 136c may move the adjustment lever 136 back into engagement with the plurality of tab slots 138 to secure the first cushion 102 at a position relative to the first shell 134. Additionally, one or more biasing elements 140, such as a plurality of springs, are disposed between the first shell 134 and the first cushion 102 to urge the first cushion 102 away from the first shell 134. That is, biasing elements 140 may provide spring force against both the first shell 134 and the first cushion 102 to urge the cushion away from the first shell 134, thus assisting in adjusting the height of the first cushion 102 relative to the first shell 134. The biasing elements 140 may include coil springs, struts, dampers, or something of the like to provide force assistance against the first shell 134 and the first cushion 102 to assist in height adjustment of the first cushion 102.

To adjust a height of the first cushion 102, an occupant presses against the lever press 136c of each adjustment lever 136 included at the first cushion 102. As a result, each adjustment lever 136 hinges at the attachment point 136a, thereby disengaging the engagement tab 136b from the plurality of tab slots 138 included at the first shell 134. The disengagement of the engagement tab 136b from one of the plurality of tab slots 138 frees the first cushion 102 from the first shell 134, thus enabling the first cushion 102 to raise and lower relative to the first shell 134. The biasing elements 140 assist in raising the first cushion 102, while the user may press down on the first cushion 102 to lower the first cushion 102. In other words, the biasing elements 140 provide ease of height adjustability for the first cushion 102 between the default position 500, the raised position 502, and other available positions. Further, one or more cushion guides 142 may be included at the first shell 134 to maintain a consistent orientation of the first cushion 102 during height adjustment. The cushion guides 142 may include protrusions that extend from the first shell 134 and engage with the first cushion 102 to prevent the first cushion 102 from shifting its orientation.

With specific reference to FIGS. 10A-10C, the footrest 108 is adjustable relative to the second shell 146 to adjust a height of the footrest 108. For example, the footrest 108 may be adjusted upward and away from the second shell 146 to accommodate a short occupant. Alternatively, the footrest 108 may be adjusted downward and toward the second shell 146 to accommodate a tall occupant. For example, with specific reference to FIG. 10A, the footrest 108 is in a default or minimum height position 600 where the footrest 108 is positioned closest to the second shell 146, thus as downward as possible. With specific reference to FIG. 10B, the footrest 108 is movable from the default position 600 to one or more extended or raised positions 602, where the footrest 108 is positioned away from the second shell 146, thus upward of the default position 600. The footrest 108 may be adjustable to a plurality of extended positions that provide the footrest surfaces 108a, 108b at a variety of different heights relative to the second shell 146, such as to accommodate occupants of different sizes.

As shown in FIG. 10C, at least one adjustment lever 144 is disposed at the footrest 108 to enable adjustment of the footrest 108 between varying positions. The adjustment lever 144 for the footrest 108 operates in a similar manner as the adjustment lever 136 for the first cushion 102 as described above. That is, the adjustment lever 144 is pivotable relative to the second shell 146 for engaging and disengaging an engagement tab of the adjustment lever 144 with one of a plurality of tab slots 148 disposed at the second shell 146 to set the height of the footrest 108 relative to the second shell 146. Disengaging the engagement tab from one of the plurality of tab slots 148 enables the footrest 108 to raise and lower relative to the second shell 146, thus adjusting the height of the footrest 108. Additionally, one or more biasing elements 150, such as a plurality of springs, are disposed between the second shell 146 and the footrest 108 to bias the footrest 108 away from the second shell 146 and thus urge the footrest 108 to the raised position 602. That is, the biasing elements 150 may provide spring force against both the second shell 146 and the footrest 108 to urge the footrest 108 away from the second shell 146, thus assisting in adjusting the height of the footrest 108 relative to the second shell 146. The biasing elements 150 may include coil springs, struts, dampers, or something of the like to provide force assistance against the second shell 146 and the footrest 108 to assist in height adjustment of the footrest 108.

To adjust a height of the footrest 108, an occupant presses against a lever press of each adjustment lever 144 included at the footrest 108. As a result, each adjustment lever 144 hinges at a pivot point, thereby disengaging the engagement tab from the plurality of tab slots 148 included at the second shell 146. The disengagement of the engagement tab from one of the plurality of tab slots 148 frees the footrest 108 from the second shell 146, thus enabling the footrest 108 to raise and lower relative to the second shell 146. The biasing elements 150 assist in raising the footrest 108, while the occupant may press down on the footrest 108 to lower the footrest 108. In other words, the biasing elements 150 provide ease of height adjustability for the footrest 108 between the default position 600, the heightened position 602, and other available positions.

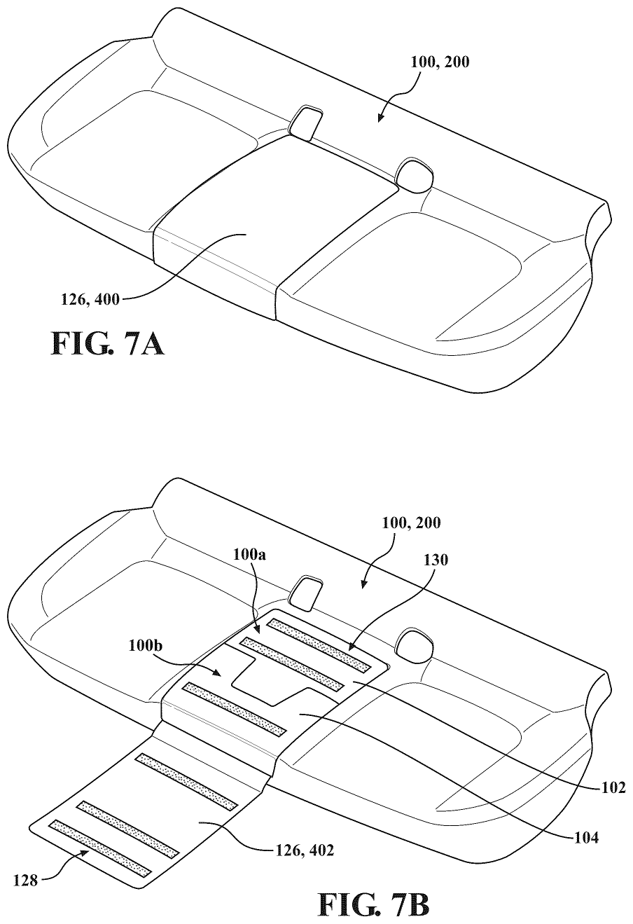

With the seat bottom 100 in the first state 200, a cover 126 may extend over and along the first cushion 102 and the second cushion 104 to provide the seating surface. Further, the cover 126 may secure the pivoting portion 100b relative to the base portion 100a to retain the seat bottom 100 in the first state 200. For example, and as shown in FIGS. 7A and 7B, the cover 126 in a first position or concealed position 400 extends over the first cushion 102 and the second cushion 104 so that the cover 126 provides the seating surface. In other words, when the cover 126 is in the concealed position 400 (FIG. 7A), the cover 126 extends over and along the first cushion 102 and the second cushion 104 so that the first cushion 102 and the second cushion 104 are beneath the cover 126 and the cover 126 conceals the first cushion 102 and the second cushion 104. The cover 126 may be securely fastened to the first cushion 102 and the second cushion 104, such as via hook and loop fasteners, button snaps, and the like. For example, a plurality of loop strips 128 are affixed to the cover 126, and a plurality of hook strips 130 are affixed to the first cushion 102 and the second cushion 104. The loop strips 128 engage with the hook strips 130 when the cover 126 is in the concealed position 400, thus securing the cover 126 to the seat bottom 100 and securing the first cushion 102 to the second cushion 104. Securing the first cushion 102 to the second cushion 104 prevents unwanted or unintentional transition of the seat bottom 100 from the first state 200 to the second state 202. Disengaging the loop strips 128 from the hook strips 130 and moving the cover 126 away from at least the base portion 100a of the seat bottom 100 or moving the cover 126 away from both the base portion 100a and the pivoting portion 100b of the seat bottom 100, positions the cover 126 in an exposed position 402 (FIG. 7B). Optionally, an end of the cover may be attached to the seat bottom 100 so that the cover is movable or pivotable about a seam formed between the cover 126 and the seat bottom 100. When the cover 126 is in the exposed position 402, the first cushion 102 and the second cushion 104 are exposed and unconcealed, thus enabling the user to move the seat bottom 100 between the first state 200 and the second state 202.

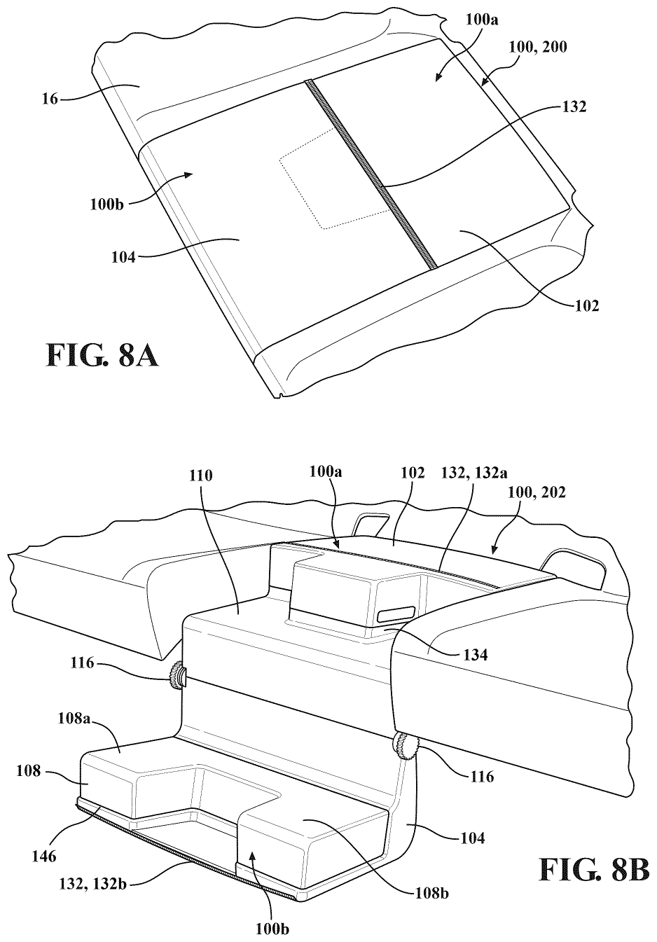

Returning the cover 126 from the exposed position 402 to the concealed position 400, such as via engaging the loop strips 128 with the hook strips 130, conceals the first cushion 102 and the second cushion 104 and maintains the seat bottom 100 in the first state 200. Optionally, and such as shown in FIGS. 8A and 8B, a connector such as a zipper 132 may connect the first cushion 102 to the second cushion 104, thus securing the seat bottom 100 in the first state 200. Securing the first cushion 102 to the second cushion 104 prevents unwanted or unintentional transition of the seat bottom 100 from the first state 200 to the second state 202. In this regard, a first portion 132a of the zipper 132 is affixed to the first cushion 102, and a second portion 132b of the zipper 132 is affixed to the second cushion 104. When the first portion 132a of the zipper 132 is engaged with the second portion 132b of the zipper 132, the seat bottom 100 is prevented from transitioning from the first state 200 to the second state 202. When the first portion 132a of the zipper 132 is disengaged with the second portion 132b of the zipper 132, the seat bottom 100 is enabled to transition between the first state 200 and the second state 202. Other connectors may be implemented, such as snap button connectors, a hook and loop connector, and the like.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicular seat assembly comprising:
a seat bottom having a base portion and a pivoting portion, the base portion having a first cushion disposed at a first shell and the pivoting portion having a second cushion disposed at a second shell and a footrest, the seat bottom adjustable between:
a first state, where the first shell, the second shell, and the footrest are concealed beneath the first cushion and the second cushion, and the first cushion and the second cushion cooperate to provide a sitting surface configured to support a user sitting at the vehicular seat assembly; and
a second state, where the pivoting portion is moved about a pivot axis away from the base portion so that the first cushion provides the sitting surface and the footrest is exposed to provide a footrest surface configured to support feet of the user sitting at the vehicular seat assembly.

2. The vehicular seat assembly of claim 1, wherein a hinge pivotally attaches the pivoting portion relative to the base portion, the hinge defining the pivot axis.

3. The vehicular seat assembly of claim 2, wherein the hinge comprises at least one selected from the group consisting of (i) a flexible hinge that extends between the pivoting portion and the base portion and (ii) a pivotal bracket attached to the pivoting portion and the base portion.

4. The vehicular seat assembly of claim 3, wherein the hinge includes a ratcheting mechanism configured to secure a position of the pivoting portion relative to the base portion at one of a plurality of positions about the pivot axis.

5. The vehicular seat assembly of claim 1, wherein, with the seat bottom in the second state, the first cushion is adjustable relative to the first shell to adjust a height of the sitting surface.

6. The vehicular seat assembly of claim 1, wherein, with the seat bottom in the second state, the footrest is adjustable relative to the second shell to adjust a height of the footrest surface.

7. The vehicular seat assembly of claim 1, wherein, with the seat bottom in the first state, a cover extends over the first cushion and the second cushion to provide the sitting surface, and with the seat bottom in the second state, the cover is removed from at least the first cushion.

8. The vehicular seat assembly of claim 7, wherein, with the seat bottom in the first state, the cover attaches to the first cushion and the second cushion via hook and loop fasteners.

9. The vehicular seat assembly of claim 1, wherein, with the seat bottom in the first state, the first cushion is connected to the second cushion to secure the seat bottom in the first state.

10. The vehicular seat assembly of claim 9, wherein, with the seat bottom in the first state, the first cushion is connected to the second cushion via a zipper.

11. A vehicular seat assembly comprising:
a bench seat having a first sitting position, a second sitting position, and a third sitting position, wherein at least one of the first sitting position, the second sitting position, and the third sitting position includes:
a seat bottom having a base portion and a pivoting portion, the base portion having a first cushion disposed at a first shell and the pivoting portion having a second cushion disposed at a second shell and a footrest, the seat bottom adjustable between:
a first state, where the first shell, the second shell, and the footrest are concealed beneath the first cushion and the second cushion, and the first cushion and the second cushion cooperate to provide a sitting surface configured to support a user sitting at the vehicular seat assembly; and
a second state, where the pivoting portion is moved about a pivot axis away from the base portion so that the first cushion provides the sitting surface and the footrest is exposed to provide a footrest surface configured to support feet of the user sitting at the vehicular seat assembly.

12. The vehicular seat assembly of claim 11, wherein a hinge pivotally attaches the pivoting portion relative to the base portion, the hinge defining the pivot axis.

13. The vehicular seat assembly of claim 11, wherein, with the seat bottom in the second state, the first cushion is adjustable relative to the first shell to adjust a height of the sitting surface.

14. The vehicular seat assembly of claim 11, wherein, with the seat bottom in the second state, the footrest is adjustable relative to the second shell to adjust a height of the footrest surface.

15. The vehicular seat assembly of claim 11, wherein, with the seat bottom in the first state, the first cushion is connected to the second cushion to secure the seat bottom in the first state.

16. A vehicle comprising:
a seat assembly including a seat bottom having a base portion and a pivoting portion, the base portion having a first cushion disposed at a first shell and the pivoting portion having a second cushion disposed at a second shell and a footrest, the seat bottom adjustable between:
a first state, where the first shell, the second shell, and the footrest are concealed beneath the first cushion and the second cushion, and the first cushion and the second cushion cooperate to provide a sitting surface configured to support a user sitting at the seat assembly; and
a second state, where the pivoting portion is moved about a pivot axis away from the base portion so that the first cushion provides the sitting surface and the footrest is exposed to provide a footrest surface configured to support feet of the user sitting at the seat assembly.

17. The vehicle of claim 16, wherein a hinge pivotally attaches the pivoting portion relative to the base portion, the hinge defining the pivot axis.

18. The vehicle of claim 16, wherein, with the seat bottom in the second state, the first cushion is adjustable relative to the first shell to adjust a height of the sitting surface.

19. The vehicle of claim 16, wherein, with the seat bottom in the second state, the footrest is adjustable relative to the second shell to adjust a height of the footrest surface.

20. The vehicle of claim 16, wherein, with the seat bottom in the first state, the first cushion is connected to the second cushion to secure the seat bottom in the first state.
